(19) United States
(12) Patent Application Publication
(10) Pub. No.: US 2024/0017438 A1
(43) Pub. Date: Jan. 18, 2024

(54) SYSTEMS AND METHODS FOR WOOD POLE AND POST TREATMENT

(71) Applicant: Louis D. Jeffrey, King Hill, ID (US)

(72) Inventor: Louis D. Jeffrey, King Hill, ID (US)

(21) Appl. No.: 17/864,687

(22) Filed: Jul. 14, 2022

(51) Int. Cl. B27K 3/02

(52) U.S. Cl. CPC B27K 3/02; B27K 2240/00

(57) ABSTRACT

A system for treatment of wood poles that includes a container placed at the top of wooden poles with a drip or wick valve system to enable preservatives that extend the life of wooden poles to be applied to the pole. Embodiments may also include electrically insulating containers that can also function as insulators for high voltage electric lines, ground wires on power poles, electric fencing and the like.

### FIELD OF THE DISCLOSURE

This disclosure generally relates to systems and methods for treating wood poles or posts. More particularly, this disclosure relates to systems and method for treating wood poles or posts with little or no need for manual attendance to the treatment systems.

### BACKGROUND

Wooden poles or posts are still frequently used for utility poles, fencing, corrals, livestock pens, and the like. Often, the wooden poles are intended to last for many decades and are located in remote outdoor areas making maintenance troublesome and difficult. In addition, the poles are often subject to extremes of temperature, extremes of weather, insects, and other animal damage, thus, necessitating frequent maintenance.

Existing systems and methods of treating wood poles and posts often require a worker to travel between poles and apply a treatment solution either by hand or with a sprayer. As noted, the poles may be distributed over large distances and in remote or otherwise hard to reach areas making application of treatment difficult and tiresome. Other drawbacks, issues, inconveniences, and difficulties with current systems and methods also exist.

### SUMMARY

Accordingly, disclosed embodiments address the above, and other, drawbacks, issues, inconveniences, and difficulties with current systems and methods. Disclosed embodiments include systems and methods for treating wooden poles including a treatment container for holding preservative therein, an attachment portion for attaching the treatment container to the top of a wooden pole, and a valve near a bottom portion of the treatment container that, when the treatment container is attached to the top of the wooden pole, is positioned above the top of the wooden pole.

In some embodiments the system includes a wick in fluid communication with the valve and, when the treatment container is attached to the top of the wooden pole, contacts the top of the wooden pole.

In some embodiments the preservative may be one or more of pentachlorophenol (penta), creosote, arsenicals, copper chromium arsenate (CCA), copper naphthenate, dichloro-octyl-isothiazolinone (DCOI), or Ammoniacal Copper Zinc Arsenate (ACZA).

In some embodiments the valve may be a drip valve. In further embodiments, a service opening enables access to the valve. Some embodiments may include a lid to cover a top of the treatment container.

In some embodiments the treatment container is an electrically insulating material. In further embodiments, the treatment may be for attaching an electrical conductor wire.

Some embodiments include a fill valve near a top portion of the treatment container. In further embodiments, the fill valve may be a floating ball valve. In still further embodiments, the system may include a fill tube to enable the preservative to be poured or pumped into the treatment container. Other embodiments also exist.

### BRIEF DESCRIPTION OF THE DRAWINGS

FIGS. 1A-1B are schematic cross-sectional views of treatment systems in accordance with disclosed embodiments.

FIG. 2 is a schematic isometric view of a treatment system in accordance with disclosed embodiments.

FIG. 3 is a schematic cross-sectional view of a treatment system in accordance with disclosed embodiments.

FIG. 4 is a schematic side view of a treatment system in accordance with disclosed embodiments.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the spirit and scope of the invention as defined by the appended claims.

### DETAILED DESCRIPTION

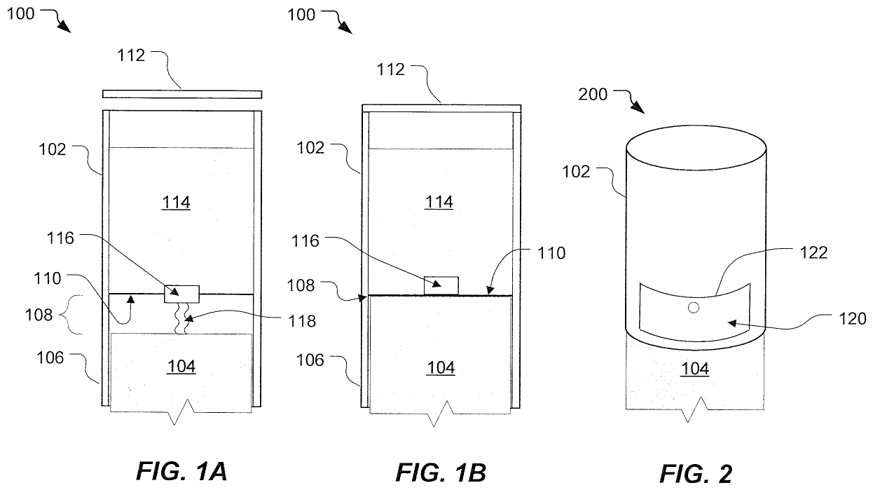

As used herein the terms “pole” and “post” are used interchangeably and intended to mean a generally elongated structure, of any cross-sectional shape (e.g., rectangular, square, circular, etc.) made of wood or wood composites and used for structures such as utility poles, docks, retaining walls, bridge pilings, fencing, corrals, livestock pens, and the like. FIGS. 1A-1B are schematic cross-sectional views of treatment systems 100 for poles in accordance with disclosed embodiments.

As schematically illustrated, embodiments of treatment system 100 may comprise a container 102 that fits over a pole 104. As indicated, embodiments of container 102 may have an attachment portion 106 that secures the container 102 to the top of pole 104. The cross-sectional shape of the attachment portion 106 may match that of the pole 104 (e.g., circular cross section for round poles, rectangular cross section for rectangular poles, etc.), but need not be so and appropriately sized (e.g., larger than the pole 104 diameter) attachment portions 106 may also be used. Likewise, attachment portion 106 may secure the container 102 to the pole 104 with fasteners (not shown) such as screws, bolts, nails, or the like.

As also indicated a gap 108 of varying size, including down to direct contact with the pole 104 as shown in FIG. 1B, may be left between the pole 104 and the bottom 110 of treatment container 102. As also indicated embodiments may include a container lid 112 that may be removable, integrally formed, partially removable, or the like.

As also indicated, treatment container 102 holds the preservative substances 114 that are used to treat to pole 104. For example, preservatives such as pentachlorophenol (penta), creosote, arsenicals (e.g., copper chromium arsenate, or CCA), copper naphthenate, dichloro-octyl-isothiazolinone (DCOI), Ammoniacal Copper Zinc Arsenate (ACZA), or the like may be stored in treatment container 102. Other preservatives may also be used.

As also indicated schematically, embodiments of treatment system 100 include one or more drip valves 116 to transfer the preservative 114 to the top of the pole 104. Drip valve 116 is configured to controllably release the preservative, either through a gravity drip or with an accompanying wick 118 or the like, onto the pole 104. For example, embodiments of drip valve 116 may have an aperture of variable size that can be set to the size desired to produce a drip rate suitable for the desired duration of treatment for the pole 104. Other configurations are also possible.

FIG. 2 illustrates an embodiment of a treatment system 200 that is generally cylindrical in shape with a circular cross-section. As illustrated, treatment container 102 may include a service opening 120 to enable access to the drip valve 116 or other system components. Embodiments of service opening 120 may also include a door 122 or other closure to secure the service opening 120.

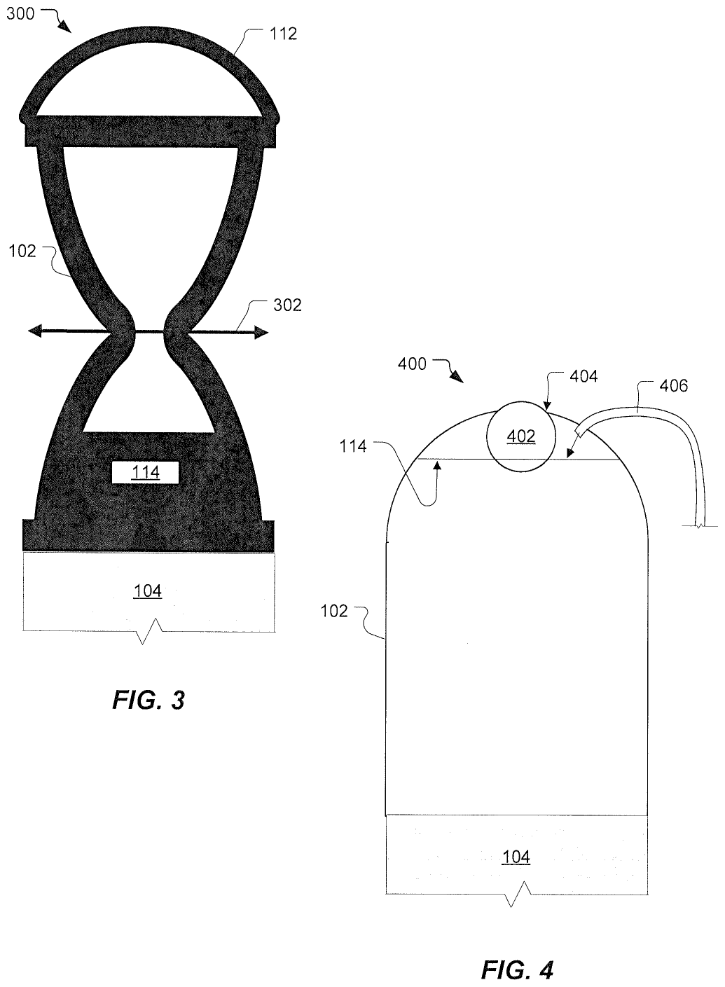

FIG. 3 illustrates an embodiment of a treatment system 300 that is also usable as an electrical insulator capable for use with electric fencing, electric utility poles, and the like. For example, embodiments of treatment system 300 may be made of glass, ceramic, or other electric insulator and appropriately shaped to attach an electric conductor wire 302 on the outer surface of treatment container 102 while also containing preservative 114 within the treatment container 102 as disclosed herein.

FIG. 4 illustrates an embodiment of a treatment system 400 that includes apparatus to refill the treatment container 102 with preservative. For example, treatment system 400 may include a ball valve 402 that is sized to seal a vent or opening 404 in the treatment container 102. A filler tube 406 may be permanently or selectively attached to the treatment container 102 to allow preservative 114 to be poured or pumped into the treatment container 102. When the preservative 114 level is sufficient to float the ball valve 402 and seal the opening 404 filling will stop either manually or automatically. Such systems 400 may be advantageous, for example, in filling treatment containers 102 that are difficult to access due to their mounted height or other conditions.

In other embodiments opening 404 may be present without the ball valve 402 to enable filling of preservative directly through the opening 404. Other configurations are also possible.

Although various embodiments have been shown and described, the present disclosure is not so limited and will be understood to include all such modifications and variations are apparent to one skilled in the art.

What is claimed is:

1. A system for treating wooden poles, the system comprising:
a treatment container for holding preservative therein;
an attachment portion for attaching the treatment container to the top of a wooden pole; and
a valve near a bottom portion of the treatment container that, when the treatment container is attached to the top of the wooden pole, is positioned above the top of the wooden pole.

2. The treatment system of claim 1 further comprising a wick in fluid communication with the valve and, when the treatment container is attached to the top of the wooden pole, contacts the top of the wooden pole.

3. The treatment system of claim 1 wherein the preservative is selected from the group consisting of:
pentachlorophenol (penta), creosote, arsenicals, copper chromium arsenate (CCA), copper naphthenate, dichloro-octyl-isothiazolinone (DCOI), or Ammoniacal Copper Zinc Arsenate (ACZA).

4. The treatment system of claim 1 wherein the valve further comprises a drip valve.

5. The treatment system of claim 1 further comprising a service opening that enables access to the valve.

6. The treatment system of claim 1 further comprising a lid to cover a top of the treatment container.

7. The treatment system of claim 1 wherein the treatment container further comprises an electrically insulating material.

8. The treatment system of claim 7 wherein the treatment container includes means for attaching an electrical conductor wire.

9. The treatment system of claim 1 further comprising a fill valve near a top portion of the treatment container.

10. The treatment system of claim 9 wherein the fill valve comprises a floating ball valve.

11. The treatment system of claim 1 further comprising a fill tube to enable the preservative to be poured or pumped into the treatment container.
